(19) United States
(12) Patent Application Publication
(10) Pub. No.: US 2026/0343185 A1
(43) Pub. Date: Oct. 29, 2026

(54) COMMUNICATION METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/485,140

(22) PCT Filed: May 17, 2023
(86) PCT No.: PCT/CN2023/094878

§ 371 Date: Nov. 17, 2025

(51) Int. Cl. H04W 4/06; H04W 8/22

(52) U.S. Cl. CPC H04W 4/06; H04W 8/22

(57) ABSTRACT

A communication technique that enables a network device to broadcast information including parameters for artificial intelligence (AI) operations in a wireless communication system. The parameters may include generic parameters applicable to multiple AI feature instances and specific parameters associated with a particular AI feature instance. Cell-specific parameters may indicate whether a cell supports an AI feature instance, configuration information such as antenna configuration, cell type, or deployment scenario, data distribution information including data sets, and AI model download information including model availability or terminal demand. Terminals receive the broadcast information periodically or in response to a request, determine applicability based on terminal type with different communication capabilities, and perform AI operations using the received parameters. Corresponding wireless communication devices with processors and memory are configured to execute the network-side and terminal-side methods, enabling flexible deployment and management of AI features across cells and terminals.

### CROSS REFERENCE TO RELATED APPLICATION

This application is a National Stage of International Application No. PCT/CN2023/094878, filed on May 17, 2023, which is incorporated by reference herein in its entirety for all purposes.

### TECHNICAL FIELD

The present disclosure relates to the field of communication technology, and in particular to a communication method, a communication device and a storage medium.

### BACKGROUND

In recent years, artificial intelligence (AI) technology has made continuous breakthroughs in many fields. AI technology is gradually cross-penetrating into other academic fields, providing new directions and methods for the development of different disciplines.

In related art, the 3rd Generation Partnership Project (3GPP) has established a research project on artificial intelligence technology in wireless air interfaces. The project aims to study the introduction of AI technology in wireless air interfaces and explore how AI technology can assist in improving the transmission technology of wireless air interfaces.

### SUMMARY

The present disclosure provides a communication method, a communication device and a storage medium.

According to a first aspect of embodiments of the present disclosure, a communication method is provided, which is performed by a network device and includes: sending broadcast information, where the broadcast information includes a parameter used for an artificial intelligence (AI) operation.

According to a second aspect of embodiments of the present disclosure, a communication method is provided, which is performed by a terminal and includes: receiving broadcast information, where the broadcast information includes a parameter used for an AI operation.

According to a third aspect of embodiments of the present disclosure, a communication device is provided, including: a sending unit, configured to send broadcast information, where the broadcast information includes a parameter used for an AI operation.

According to a fourth aspect of embodiments of the present disclosure, a communication device is provided, including: a receiving unit, configured to receive broadcast information, where the broadcast information includes a parameter used for an AI operation.

According to a fifth aspect of embodiments of the present disclosure, a communication device is provided, including: a processor; and a memory for storing instructions executable by the processor; where the processor is configured to perform the communication method according to the first aspect of embodiments of the present disclosure.

According to a sixth aspect of embodiments of the present disclosure, a communication device is provided, including: a processor; and a memory for storing instructions executable by the processor; where the processor is configured to perform the communication method according to the second aspect of embodiments of this disclosure.

According to a seventh aspect of embodiments of the present disclosure, a storage medium is provided, in which instructions are stored. The instructions in the storage medium, upon being executed by a processor of a network device, cause the network device to perform the communication method according to the first aspect of embodiments of the present disclosure.

In an eighth aspect of the embodiments of the present disclosure, a storage medium is provided, in which instructions are stored. The instructions in the storage medium, upon being executed by a processor of a terminal, cause the terminal to perform the communication method according to the second aspect of embodiments of the present disclosure.

According to a ninth aspect of embodiments of the present disclosure, an AI communication system is provided and includes: a network device, configured to perform the method according to the first aspect; and a terminal, configured to perform the method according to the second aspect.

It should be understood that the foregoing general description and the following detailed description are exemplary and explanatory only and are not restrictive of the embodiments of the present disclosure.

### BRIEF DESCRIPTION OF THE DRAWINGS

The accompanying drawings, which are incorporated in and constitute a part of this specification, illustrate embodiments consistent with the present invention and, together with the description, serve to explain the principles of the embodiments of the present invention.

FIG. 1 is a schematic diagram showing a wireless communication system according to an exemplary embodiment.

FIG. 2 is a flow chart showing a communication method according to an exemplary embodiment.

FIG. 3 is a flow chart showing another communication method according to an exemplary embodiment.

FIG. 4 is a flow chart showing a communication method according to an exemplary embodiment.

FIG. 5 is a flow chart showing another communication method according to an exemplary embodiment.

FIG. 6 is a block diagram showing a communication device according to an exemplary embodiment.

FIG. 7 is a schematic diagram showing interactions of a communication system according to an exemplary embodiment.

FIG. 8 is a block diagram showing a communication device according to an exemplary embodiment.

FIG. 9 is a block diagram of an apparatus for AI communication according to an exemplary embodiment.

FIG. 10 is a block diagram of an apparatus for AI communication according to an exemplary embodiment.

### DETAILED DESCRIPTION

Here, exemplary embodiments will be described in detail, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present disclosure. Instead, they are only examples of apparatuses and methods consistent with some aspects according to some embodiments of the present disclosure.

The communication method according to some embodiments of the present disclosure can be applied to the wireless communication system shown in FIG. 1. Referring to FIG. 1, the wireless communication system includes a network device and a terminal. The terminal is connected to the network device through wireless resources and performs data transmission.

It is understandable that the wireless communication system shown in FIG. 1 is only for schematic illustration, and the wireless communication system may also include other network devices, such as core network devices, wireless relay devices, and wireless backhaul devices, which are not shown in FIG. 1. The embodiments of the present disclosure do not limit the number of network devices and terminals included in the wireless communication system.

It can be further understood that the wireless communication system according to some embodiments of the present disclosure is a network that provides wireless communication functions. The wireless communication system can adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), carrier sense multiple access with collision avoidance. According to the capacity, rate, delay and other factors of different networks, the network can be divided into 2G (English: generation) network, 3G network, 4G network or future evolution network, such as 5G network, which can also be called new radio (NR). For the convenience of description, the present disclosure sometimes simply refers to a wireless communication network as a network.

Further, the network device involved in the present disclosure may also be referred to as a wireless access network device. The wireless access network device may be: a base station, an evolved node B, a home base station, an access point (AP) in a wireless fidelity (WIFI) system, a wireless relay node, a wireless backhaul node, a transmission point (TP), a transmission and reception point (TRP), or the like. It may also be a gNB in the NR system, or it may also be a component or a part of a base station. It should be understood that in some embodiments of the present disclosure, the specific technology and specific device form adopted by the network device are not limited. In the present disclosure, the network device may provide communication coverage for a specific geographical area, and may communicate with a terminal located in the coverage area (cell). In addition, when a vehicle-to-everything (V2X) communication system is concerned, the network device may also be a vehicle-mounted device.

Furthermore, the terminal involved in the present disclosure may also be referred to as a terminal device, a user equipment (UE), a mobile station (MS), a mobile terminal (MT), or the like, which is a device that provides voice and/or data connectivity to users. For example, the terminal may be a handheld device with a wireless connection function, a vehicle-mounted device, or the like. At present, some examples of terminals are: a smart mobile phone, a customer premise equipment (CPE), a pocket personal computer (PPC), a handheld computer, a personal digital assistant (PDA), a laptop computer, a tablet computer, a wearable device, a vehicle-mounted device, or the like. In addition, when the vehicle-to-everything (V2X) communication system is concerned, the terminal device may also be a vehicle-mounted device. It should be understood that the embodiments of the present disclosure do not limit the specific technology and specific device form adopted by the terminal.

In recent years, artificial intelligence (AI) technology has made continuous breakthroughs in many fields. AI technology is gradually cross-penetrating into other disciplines, providing new directions and methods for the development of different disciplines.

In the related art, the 3rd Generation Partnership Project (3GPP) has set up a research project on artificial intelligence technology in wireless air interfaces. The project aims to study the introduction of AI technology in wireless air interfaces and, in addition, explore how AI technology can assist in improving the transmission technology of wireless air interfaces.

In the research on AI communications, AI instance may include: AI-based channel state information (CSI) enhancement, AI-based beam management, and AI-based positioning.

It is understandable that AI instance can also be called AI feature. In AI-based communications, communication operations are performed based on AI instance to achieve a certain communication scenario. For example, AI is used to predict channel information in the time domain, such as AI-based CSI compression. Another example is AI-based beam management in the space domain. Generally, the AI feature is defined in the protocol.

It is understandable that in the above instances, each AI instance is used in the communication process, and will correspond to different AI operations, with different AI operations corresponding to different parameter configurations. Due to the different application cases, in the current communication network, the configuration for AI operations in the network can be common to all terminals, such as which AI instance this cell supports, and which data sets are used in the cell to test AI models.

In some scenarios, multiple AI functions are defined for a certain AI instance. For example, for beam enhancement, AI function 1 supports the prediction of the identity (ID) of the best beam, and AI function 2 supports the prediction of the best beam and the measurement results of the corresponding beam. The implementation of AI functions relies on AI models. Different AI functions may be implemented by different AI models. In addition, the number of AI models corresponding to each AI function may also be different. This makes the parameters for the operation of AI functions or AI models different, such as the parameters for activating or switching AI functions or AI models.

In the related art of the current communication network, it is not clear how to configure the parameters of AI operations during communication.

Based on this, the present disclosure proposes a communication method to clearly configure the AI operation parameters, so as to facilitate subsequent communication based on the AI operation parameters.

A communication method proposed in an embodiment of the present disclosure achieves, by broadcasting parameters used for AI operation through broadcast information, configuration of relevant communication operation parameters of AI based on the broadcast information.

It should be noted that the parameters used for AI operation mentioned in the following embodiments of the present disclosure may include parameters used for operating AI functions or parameters used for operating AI models. For ease of description, the following embodiments refer to the parameters used for operating AI functions as a parameter for AI operation.

It should be noted that the parameter for AI operations mentioned in the following embodiments of the present disclosure can be divided into generic parameters and specific parameters according to the scope of application.

It can be understood that the parameter for AI operations mentioned in the following embodiments, specifically generic parameters or specific parameters, can be adjusted according to actual application scenarios.

It should be noted that the AI feature instance mentioned in the following embodiments of the present disclosure may also be referred to as AI instance.

Exemplarily, in the communication method according to some embodiments of the present disclosure, the AI operation parameters carried in the broadcast information can be understood as the parameter for AI operations.

Exemplarily, in the communication method according to some embodiments of the present disclosure, the parameter for AI operations include at least one of the following: parameters for AI-based CSI enhancement operations, parameters for AI-based beam management operations, and parameters for AI-based positioning operations.

It should be further explained that the parameter for AI operations involved in the following embodiments of the present disclosure include one or more of: parameters for AI-based CSI enhancement operations, parameters for AI-based beam management operations, and parameters for AI-based positioning operations.

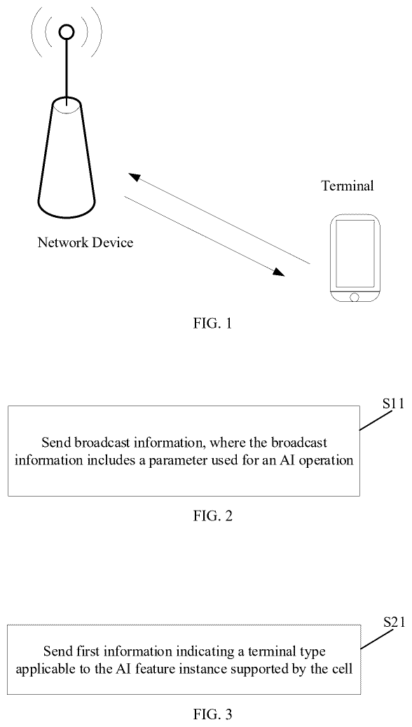

FIG. 2 is a flow chart of a communication method according to an exemplary embodiment. As shown in FIG. 2, the communication method, performed by a network device, includes the following steps.

In step S11, broadcast information is sent, where the broadcast information includes a parameter for AI operation.

In some embodiments of the present disclosure, the broadcast information includes the parameter for AI operation, and the network device can configure, through the broadcast information, the parameters for the AI-related communication operations.

In the communication method according to some embodiments of the present disclosure, multiple AI instances can be sent based on one broadcast message or through multiple broadcast messages.

In one implementation according to some embodiments of the present disclosure, the parameter for AI operation includes at least one of the following: a generic parameter and a specific parameter.

In some embodiments of the present disclosure, the generic parameter can be understood as being applicable to AI operations of all AI feature instances, while the specific parameter is dedicated to AI operations of a single AI feature instance.

For example, if parameter A is applicable to AI operations of all current AI instances, then parameter A is considered a generic parameter; if parameter B is a parameter specific to AI operations of AI instance b, then parameter B is considered a specific parameter.

In some embodiments of the present disclosure, the parameter for AI operation includes a generic parameter(s).

In some embodiments of the present disclosure, the parameter for AI operation includes a specific parameter(s).

In some embodiments of the present disclosure, the parameter for AI operation includes a generic parameter(s) and a specific parameter(s).

In one implementation according to some embodiments of the present disclosure, the parameter for AI operation includes a cell parameter, and the cell is a cell that sends the broadcast information.

In some embodiments of the present disclosure, the cell parameter includes at least one of the following: whether the cell supports an AI feature instance; configuration information corresponding to the cell; data distribution information of the cell; and AI model download information of the cell.

Exemplarily, the cell parameter for AI operation in some embodiments of the present disclosure includes whether the cell supports an AI feature instance.

The cell parameter for AI operation may include at least one of the following: whether the cell supports AI-based CSI compression, whether the cell supports AI-based beam prediction, and whether the cell supports AI-based positioning.

In a communication method according to some embodiments of the present disclosure, the network device may indicate the type of terminal in response to the cell supporting an AI feature instance.

FIG. 3 is a flow chart of another communication method according to an exemplary embodiment. In one implementation according to some embodiments of the present disclosure, as shown in FIG. 3, the following steps are included.

In step S21, first information is sent, where the first information is indicative of a terminal type applicable to the AI feature instance supported by the cell.

In some embodiments of the present disclosure, the terminal type includes a first-type terminal or a second-type terminal, and the first-type communication terminal and the second-type communication terminal have different communication capabilities. For example, the capabilities of the terminal may include transceiver bandwidth, the number of transceiver antennas, the maximum number of bits of a transmission block, and processing time delay. When referring to different communication capabilities, one or more of the transceiver bandwidth, the number of transceiver antennas, the maximum number of bits of the transmission block, and the processing time delay may be different.

Exemplarily, the terminal type may include: a normal terminal, a new radio light-capability (NR-lite) terminal. For example, the first-type terminal may be an NR-lite terminal, and the second-type terminal may be a normal terminal.

In one implementation according to some embodiments of the present disclosure, the cell parameter for AI operation includes configuration information corresponding to the cell.

Exemplarily, the configuration information used for AI operation corresponding to the cell includes at least one of the following: antenna configuration information; cell type information; and cell scenario information.

Exemplarily, the antenna configuration information may include at least one of the following: cell user density, communication frequency band, supported communication standards, and the like.

Exemplarily, the cell type information may include at least one of the following: indoor cell, outdoor cell, indoor-outdoor integrated cell, macro cell, micro cell, millimeter wave cell, and the like.

Exemplarily, the scenario information of the cell includes: urban scenario, rural scenario, indoor scenario, transportation scenario, home scenario, other scenarios, and the like.

In one implementation according to some embodiments of the present disclosure, the cell parameter for AI operation includes AI model download information of the cell.

Exemplarily, the AI model download information for AI operation includes at least one of the following (I) to (III):
(I) Whether the cell provides an AI model for download.

Exemplarily, whether the cell provides an AI model for download includes at least one of the following situations: the cell provides an AI model available for download; or the cell does not provide an AI model available for download.
(II) Model information of the AI model that the cell provides for download.

Exemplarily, the model information of the AI model that the cell can provide for download includes: model identity, AI function, or the like.
(III) Demand information of the terminal corresponding to the AI model.

In one implementation according to some embodiments of the present disclosure, the cell parameter for AI operation includes data distribution information of the cell.

Exemplarily, the data distribution information of the cell may include mathematical distribution characteristics corresponding to the data of the cell, including overall distribution, geometric distribution and the like.

In one implementation according to some embodiments of the present disclosure, the data distribution information of the cell includes: data set information indicating the data distribution of the cell.

It can be understood that the data distribution of the cell can be represented by the data set information.

In one implementation according to some embodiments of the present disclosure, the data set information is indicative of the correspondence between a data set(s) and a terminal type(s).

Exemplarily, the cell data distribution may be represented based on the data set. For example, the data in data set #1 is distributed as a whole, and the data in data set #2 is distributed geometrically.

Exemplarily, the data set information may include the correspondence between terminals and data sets. For example, data set #1 is used for type A terminals and data set #2 is used for type B terminals.

Exemplarily, the parameter for AI operation in some embodiments of the present disclosure includes the information indicating data distribution of cell, for example, the data set information reflecting the data distribution of the cell, such as ID(s) of the data set(s).

The data distribution information of the cell may be sent based on a system message. In response to a system message including the data distribution information of the cell, the data distribution information of the cell may further include data set information used for different terminals. For example, for a normal terminal, data set #1 is used; and for an NR-lite terminal, data set #2 is used.

In the communication method according to some embodiments of the present disclosure, the broadcast information including the AI operation parameter may be a broadcast information dedicated to the AI operation, or may be broadcast information applicable to both AI operation and non-AI operation.

In one implementation according to some embodiments of the present disclosure, the broadcast information is broadcast information dedicated to the AI operation.

Exemplarily, contents of the broadcast information are all related to AI operations.

In one implementation according to some embodiments of the present disclosure, the broadcast information includes broadcast information for the AI operation and broadcast information for the non-AI operation.

Exemplarily, the broadcast information may include both content related to AI operations and content unrelated to the AI operations.

In one implementation according to some embodiments of the present disclosure, the AI operation corresponds to multiple AI feature instances, and the broadcast information corresponding to the multiple AI feature instances can be sent through one message, that is, the broadcast information corresponding to the multiple AI feature instances is a single broadcast message.

In one implementation according to some embodiments of the present disclosure, the AI operation corresponds to multiple AI feature instances, and the broadcast information corresponding to the multiple AI feature instances can be sent through different messages, that is, the broadcast information corresponding to the multiple AI feature instances includes multiple broadcast messages, and the number of the multiple broadcast messages is the same as or different from the number of the AI feature instances.

Exemplarily, a common parameter(s) for CSI-related and beam management-related AI operations may be configured, and included in broadcast information with multiple-input multiple-output (MIMO) parameters.

Exemplarily, the common parameter(s) for CSI-related and beam management-related AI operations may be configured and included in the broadcast information with MIMO parameters; and a common parameter(s) for positioning-related AI operations may be configured and included in the broadcast information with positioning parameters.

In the communication method according to some embodiments of the present disclosure, the broadcast information including the AI operation parameters may be sent periodically or sent based on demand.

When referring to sending based on demand, it can be understood as that the terminal, when requiring to read the information, sends a request message to the network device, and the network broadcasts only after receiving the request message.

In one implementation according to some embodiments of the present disclosure, the implementation of sending broadcast information includes at least one of the following manners (a) and (b).
(a) Sending based on a preset period.

Exemplarily, the preset period may be in one of the following forms, including: absolute time, communication time unit, and AI processing time unit.

Furthermore, the absolute time includes seconds, milliseconds, microseconds, and the like.

The communication time unit include: Orthogonal Frequency Division Multiplexing (OFDM) symbol, slot, subslot, sampling interval of OFDM symbols, and the like.

The AI time unit is used to describe the time unit of AI communication. It can be understood that the AI time unit is defined as the basic time unit used to measure AI processing tasks.
(b) Sending in response to receiving a sending request.

Exemplarily, the network device sends broadcast information in response to receiving a sending request sent by the terminal (which can also be understood as receiving a request information for requesting to send AI operation parameters).

It should be noted that those skilled in the art can understand that the various implementation methods/embodiments involved in the embodiments of the present disclosure can be used in conjunction with the aforementioned embodiments or can be used independently. Whether used alone or in conjunction with the aforementioned embodiments, the implementation principle is similar. In the implementations of the present disclosure, some embodiments are described in terms of implementations used together. However, those skilled in the art can understand that such examples are not restrictive of the embodiments of the present disclosure.

Based on the same concept, embodiments of the present disclosure also provide a communication method executed by a terminal. In the communication method, AI operation parameters are configured based on broadcast information.

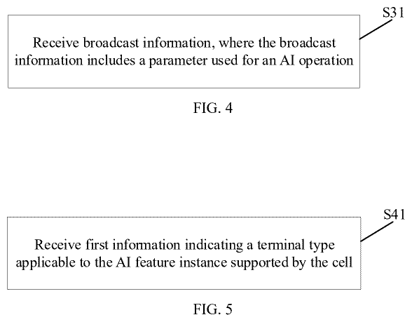

FIG. 4 is a flow chart of a communication method according to an exemplary embodiment. In some embodiments, as shown in FIG. 4, the communication method is performed by a terminal and includes the following steps.

In step S31, broadcast information is received.

In some embodiments of the present disclosure, the broadcast information includes a parameter for AI operation.

In some embodiments of the present disclosure, the broadcast information includes the parameter for AI operation, and the terminal can receive the broadcast information to enable the network device to configure the parameters for AI-related communication operations.

The broadcast information received by the terminal in some embodiments of the present disclosure is the same as the broadcast information sent by the network device, and the scenario for the terminal to receive the broadcast information is similar to the scenario for the network device to send the broadcast information. Therefore, for the same scenario in the communication method, the relevant description in some embodiments of the above-mentioned terminal device can be referred to, which will not be elaborated here.

In one implementation of the disclosed embodiment, the parameter for AI operation includes: a generic parameter and/or a specific parameter, where the generic parameter is applicable to AI operations of all AI feature instances; and the specific parameter is dedicated to AI operations of a single AI feature instance.

In one implementation according to some embodiments of the present disclosure, the parameter for AI operation includes a cell parameter of the broadcast information, where the cell parameter includes at least one of the following: whether the cell supports an AI feature instance; configuration information corresponding to the cell; data distribution information of the cell; and AI model download information of the cell.

FIG. 5 is a flow chart of another communication method according to an exemplary embodiment. In one implementation according to some embodiments of the present disclosure, as shown in FIG. 5, receiving the cell parameter, including an AI instance supported by the cell, is implemented by the following steps.

In step S41, first information is received, where the first information is indicative of a terminal type applicable to the AI feature instance supported by the cell.

In some embodiments of the present disclosure, the terminal type includes a first-type terminal or a second-type terminal, and the first-type communication terminal and the second-type communication terminal have different communication capabilities.

In one implementation according to some embodiments of the present disclosure, the configuration information corresponding to the cell includes at least one of the following: antenna configuration information; cell type information; and cell scenario information.

In one implementation according to some embodiments of the present disclosure, the AI model download information of the cell includes at least one of the following.
(I) Whether the cell provides an AI model for download.

Exemplarily, whether the cell provides an AI model for download includes at least one of the following situations: the cell provides an AI model available for download; or the cell does not provide an AI model available for download.
(II) Model information of the AI model that the cell provides for download.

Exemplarily, the model information of the AI model that the cell can provide for download includes: model identity, AI function, or the like.
(III) Demand information of the terminal corresponding to the AI model.

In one implementation according to some embodiments of the present disclosure, the data distribution information of the cell includes: data set information indicating the data distribution of the cell.

In one implementation according to some embodiments of the present disclosure, the data set information is indicative of the correspondence between a data set(s) and a terminal type(s).

In one implementation according to some embodiments of the present disclosure, the broadcast information includes broadcast information of AI operation and broadcast information of non-AI operation.

In one implementation according to some embodiments of the present disclosure, the AI operation corresponds to multiple AI feature instances, and the broadcast information corresponding to the multiple AI feature instances is a single broadcast message, or multiple broadcast messages.

In one implementation according to some embodiments of the present disclosure, the implementation of sending the broadcast information includes at least one of the following.
(a) Sending based on a preset period.

Exemplarily, the preset period may be in one of the following forms, including: absolute time, communication time unit, and AI processing time unit.

Furthermore, the absolute time includes seconds, milliseconds, microseconds, and the like.

The communication time unit include: OFDM symbol, slot, subslot, sampling interval of OFDM symbols, and the like.

The AI time unit is used to describe the time unit of AI communication. It can be understood that the AI time unit is defined as the basic time unit used to measure AI processing tasks.
(b) Sending in response to receiving a sending request.

It can be understood that the implementation process of the communication method performed by the terminal in some embodiments of the present disclosure is similar to that of the communication method performed by the network device. The similarities will not be repeated here, and reference may be made to the above-mentioned implementation process of the communication method performed by the network device.

The communication method according to some embodiments of the present disclosure is applicable to the implementation process of interaction between a terminal and a network device in a communication system.

Based on the same concept, embodiments of the present disclosure provide a communication system, which includes a terminal and a network device that perform the above communication method.

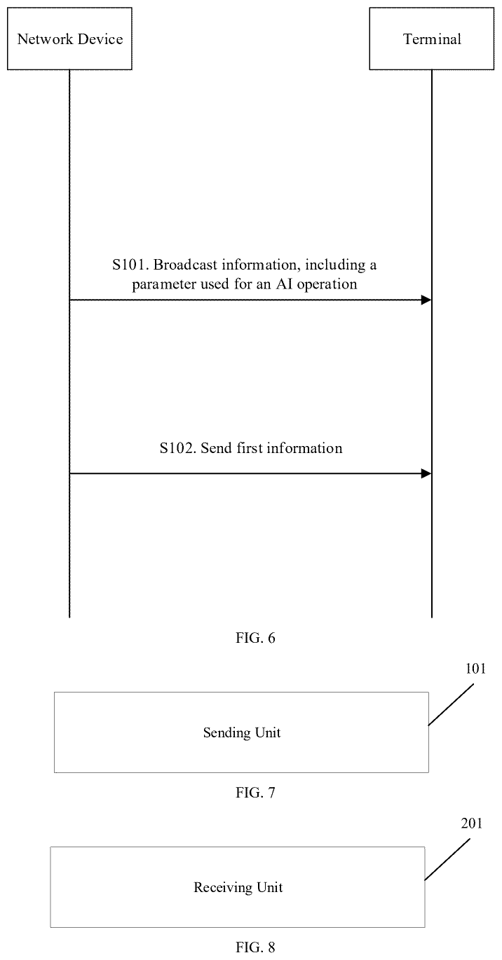

FIG. 6 is a schematic diagram illustrating a method interaction of a communication system according to an exemplary embodiment of the present disclosure. As shown in FIG. 6, some embodiments of the present disclosure relate to a communication system, and the method includes the follow steps.

In step S101, the network device sends broadcast information, and the terminal receives the broadcast information.

In one implementation, the broadcast information includes a parameter for AI operation.

In one implementation, the parameter for AI operation includes a parameter of cell sending the broadcast information, where the cell parameter includes at least one of the following: whether the cell supports an AI feature instance; configuration information corresponding to the cell; data distribution information of the cell; and AI model download information of the cell.

In step S102, the network device sends first information, and the terminal receives the first information.

In one implementation, the first information is indicative of the terminal type applicable to the AI feature instance supported by the cell.

In one implementation, the terminal type includes a first-type terminal or a second-type terminal, where the first-type communication terminal and the second-type communication terminal have different communication capabilities.

In one implementation, the first information is indicative of the terminal type applicable to the AI feature instance supported by the cell.

In one implementation, the terminal type includes a first-type terminal or a second-type terminal, where the first-type communication terminal and the second-type communication terminal have different communication capabilities.

The positioning measurement method involved in some embodiments of the present disclosure may include at least one of steps S101 to S102. For example, step S101 can be implemented as an independent embodiment, step S102 can be implemented as an independent embodiment, and step S101+step S102 can be implemented as an independent embodiment. At least some embodiments of step S101 and some embodiments of step S102, for example, the network device sending broadcast information in step S102 +the network device sending the first information in step S102, can be implemented as an independent embodiment, but is not limited thereto. In some embodiments, the network device sending broadcast information and the terminal receiving broadcast information in step S101 can be exchanged in order or executed simultaneously. The network device sending the first information and the terminal receiving the first information in step S102 can be exchanged in order or executed simultaneously. In some embodiments, step S102 is optional, and one or more of these steps can be omitted or replaced in different embodiments.

Based on the same concept, embodiments of the present disclosure also provide an AI communication device.

FIG. 7 is a block diagram of a communication device according to an exemplary embodiment. As shown in FIG. 7, embodiments of the present disclosure provide a communication device. The communication device includes a sending unit 101.

The sending unit 101 is configured to send broadcast information, where the broadcast information includes a parameter for AI operation.

In one implementation, the parameter for AI operation includes: a generic parameter and/or a specific parameter, where the generic parameter is applicable to AI operations of all AI feature instances; and the specific parameter is specific to AI operations of a single AI feature instance.

In one implementation, the parameter for AI operation includes a parameter of cell sending the broadcast information, where the cell parameter includes at least one of the following: whether the cell supports an AI feature instance; configuration information corresponding to the cell; data distribution information of the cell; and AI model download information of the cell.

In one implementation, the sending unit 101 is further configured to send first information, where the first information is indicative of a terminal type applicable to the AI feature instance supported by the cell. The terminal type includes a first-type terminal or a second-type terminal, and the first-type communication terminal and the second-type communication terminal have different communication capabilities.

In one implementation, the configuration information corresponding to the cell includes at least one of the following: antenna configuration information; cell type information; and cell scenario information.

In one implementation, the data distribution information of the cell includes: data set information for indicating data distribution of the cell.

In one implementation, the broadcast information includes: data set information for indicating cell data distribution, where the data set information is indicative of a correspondence between a data set and a terminal type.

In one implementation, the AI model download information of the cell includes at least one of the following: whether the cell provides an AI model for download; model information of the AI model that the cell provides for download; and demand information of a terminal corresponding to the AI model.

In one implementation, the broadcast information is broadcast information dedicated to AI operations.

In one implementation, the broadcast information includes broadcast information of AI operations and broadcast information of non-AI operations.

In one implementation, the AI operation corresponds to multiple AI feature instances, and the broadcast information corresponding to the multiple AI feature instances is a single broadcast message, or includes multiple broadcast messages.

In one implementation, sending the broadcast information includes: sending based on a preset period; or sending in response to receiving a sending request.

Based on the same concept, embodiments of the present disclosure also provide an AI communication device.

FIG. 8 is a block diagram showing a communication device according to an exemplary embodiment.

As shown in FIG. 8, embodiments of the present disclosure provide a communication device, including a receiving unit 201.

The receiving unit 201 is configured to receive broadcast information, which includes a parameter for AI operation.

In one implementation, the parameter for AI operation includes: a generic parameter and/or a specific parameter, where the generic parameter is applicable to AI operations of all AI feature instances; and the specific parameter is specific to AI operations of a single AI feature instance.

In one implementation, the parameter for AI operation includes a parameter of cell sending the broadcast information, where the cell parameter includes at least one of the following: whether the cell supports an AI feature instance; configuration information corresponding to the cell; data distribution information of the cell; and AI model download information of the cell.

In one implementation, the receiving unit 201 is further configured to receive first information, where the first information is indicative of a terminal type applicable to the AI feature instance supported by the cell. The terminal type includes a first-type terminal or a second-type terminal, and the first-type communication terminal and the second-type communication terminal have different communication capabilities.

In one implementation, the configuration information corresponding to the cell includes at least one of the following: antenna configuration information; cell type information; and cell scenario information.

In one implementation, the data distribution information of the cell includes: data set information for indicating data distribution of the cell.

In one implementation, the broadcast information includes: data set information for indicating cell data distribution, where the data set information is indicative of a correspondence between a data set and a terminal type.

In one implementation, the AI model downloads information of the cell includes at least one of the following: whether the cell provides an AI model for download; model information of the AI model that the cell provides for download; and demand information of a terminal corresponding to the AI model.

In one implementation, the broadcast information is broadcast information dedicated to AI operations.

In one implementation, the broadcast information includes broadcast information of AI operations and broadcast information of non-AI operations.

In one implementation, the AI operation corresponds to multiple AI feature instances, and the broadcast information corresponding to the multiple AI feature instances is a single broadcast message, or includes multiple broadcast messages.

In one implementation, receiving the broadcast information includes: receiving based on a preset period; or receiving in response to receiving the broadcast information sent by the network device.

Regarding the device in the above embodiments, the specific manner in which each unit performs operations has been described in detail in some embodiments of the method, and will not be elaborated here.

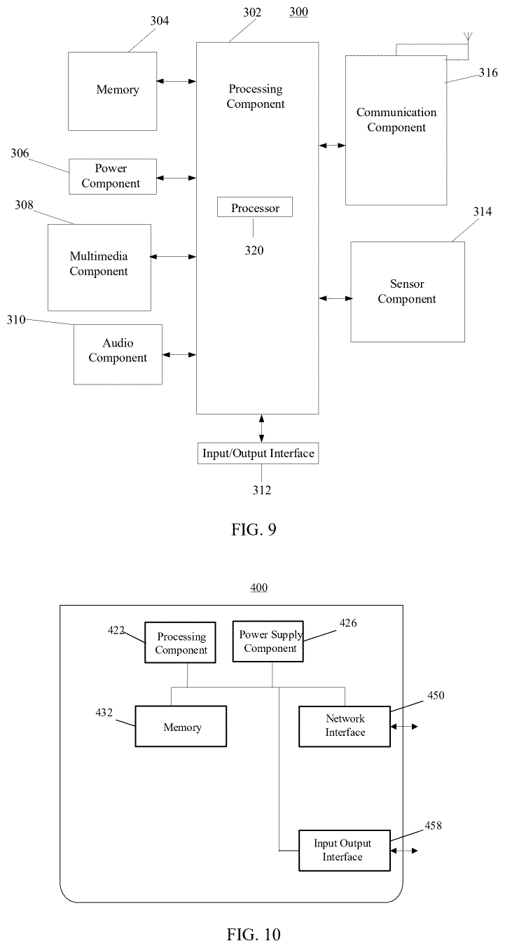

FIG. 9 is a schematic diagram of a communication device according to an exemplary embodiment. For example, the terminal 300 may be a mobile phone, a computer, a digital broadcast terminal, a messaging device, a game console, a tablet device, a medical device, a fitness device, a personal digital assistant, or the like.

Referring to FIG. 9, the terminal 300 may include one or more of the following components: a processing component 302, a memory 304, a power component 306, a multimedia component 308, an audio component 310, an input/output (I/O) interface 312, a sensor component 314, and a communication component 316.

The processing component 302 generally controls the overall operation of the terminal 300, such as operations associated with display, phone calls, data communications, camera operations, and recording operations. The processing component 302 may include one or more processors 320 to execute instructions to complete all or part of the steps of the method as described above. In addition, the processing component 302 may include one or more modules to facilitate the interaction between the processing component 302 and other components. For example, the processing component 302 may include a multimedia module to facilitate the interaction between the multimedia component 308 and the processing component 302.

The memory 304 is configured to store various types of data to support operations on the terminal 300. Examples of such data include instructions for any application or method operating on the terminal 300, contact data, phone book data, messages, pictures, videos, and the like. The memory 304 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 306 provides power to the various components of the terminal 300. The power component 306 may include a power management system, one or more power supplies, and other components associated with generating, managing, and distributing power for the terminal 300.

The multimedia component 308 includes a screen that provides an output interface between the terminal 300 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 308 includes a front camera and/or a rear camera. When the terminal 300 is in an operating mode, such as a shooting mode or a video mode, the front camera and/or the rear camera may receive external multimedia data. Each front camera and the rear camera may be a fixed optical lens system or have a focal length and optical zoom capability.

The audio component 310 is configured to output and/or input audio signals. For example, the audio component 310 includes a microphone (MIC), and when the terminal 300 is in an operating mode, such as a call mode, a recording mode, and a speech recognition mode, the microphone is configured to receive an external audio signal. The received audio signal may be further stored in the memory 304 or sent via the communication component 316. In some embodiments, the audio component 310 also includes a speaker for outputting audio signals.

Input/output interface 312 provides an interface between processing component 302 and peripheral interface modules, such as keyboards, click wheels, buttons, and the like. These buttons may include, but are not limited to, a home button, a volume button, a start button, and a lock button.

The sensor component 314 includes one or more sensors for providing various aspects of status assessment for the terminal 300. For example, the sensor component 314 can detect the turn-on/-off state of the terminal 300, the relative positioning of components, such as the display and keypad of the terminal 300. The sensor component 314 can also detect the position change of the terminal 300 or a component of the terminal 300, the presence or absence of user contact with the terminal 300, the orientation or acceleration/deceleration of the terminal 300, and the temperature change of the terminal 300. The sensor component 314 may include a proximity sensor configured to detect the presence of nearby objects without any physical contact. The sensor component 314 may also include an optical sensor, such as a CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate wired or wireless communication between the terminal 300 and other devices. The terminal 300 can access a wireless network based on a communication standard, such as WiFi, 2G, 3G, or a combination thereof. In an exemplary embodiment, the communication component 316 receives a broadcast signal or broadcast-related information from an external broadcast management system via a broadcast channel. In an exemplary embodiment, the communication component 316 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an exemplary embodiment, the terminal 300 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the method as described above.

In an exemplary embodiment, a non-transitory computer-readable storage medium including instructions is also provided, such as the memory 304 including instructions, where the instructions may be executed by the processor 320 of the terminal 300 to perform the methods as described above. For example, the non-transitory computer-readable storage medium may be a ROM, a random access memory (RAM), a CD-ROM, a magnetic tape, a floppy disk, an optical data storage device, or the like.

FIG. 10 is a schematic diagram of another communication device according to an exemplary embodiment. For example, device 400 may be provided as a base station or a server. Referring to FIG. 10, device 400 includes a processing component 422, which further includes one or more processors, and a memory resource represented by a memory 432 for storing instructions executable by processing component 422, such as an application. The application stored in memory 432 may include one or more of each A module corresponding to a set of instructions. In addition, the processing component 422 is configured to execute instructions to perform the above method.

The device 400 may also include a power component 426 configured to perform power management of the device 400, a wired or wireless network interface 450 configured to connect the device 400 to a network, and an input/output (I/O) interface 458. The device 400 may operate based on an operating system stored in the memory 432, such as Windows Server™, Mac OS X™, Unix™, Linux™, FreeBSD™, or the like.

In an exemplary embodiment, a non-transitory computer-readable storage medium including instructions is also provided, such as a memory 432 including instructions, which can be executed by the processing component 422 of the device 400 to perform the above method. For example, the non-transitory computer-readable storage medium can be a ROM, a random access memory (RAM), a CD-ROM, a magnetic tape, a floppy disk, an optical data storage device, and the like.

Embodiments of this disclosure provide an AI communication method, a device and a storage medium. In some embodiments, the terms “communication method”, “information processing method”, “communication method”, and the like can be replaced with each other, the terms “communication device”, “information processing device”, and the like can be replaced with each other, and the terms “information processing system”, “communication system”, and the like can be replaced with each other.

The embodiments of the present disclosure are not exhaustive, but are only illustrative of some embodiments, and are not intended to be a specific limitation on the protection scope of the present disclosure. In the absence of contradiction, each step in a certain embodiment can be implemented as an independent embodiment, and the steps can be arbitrarily combined. For example, a solution after removing some steps in a certain embodiment can also be implemented as an independent embodiment, and the order of the steps in a certain embodiment can be arbitrarily exchanged. In addition, optional implementations in a certain embodiment can be arbitrarily combined; in addition, the embodiments can be arbitrarily combined, for example, some or all of the steps of different embodiments can be arbitrarily combined, and a certain embodiment can be arbitrarily combined with optional implementations of other embodiments.

In each embodiment of the present disclosure, if there is no special explanation and logical conflict, the terms and/or descriptions between the embodiments are consistent and can be referenced to each other, and the technical features in different embodiments can be combined to form a new embodiment according to their inherent logical relationship. The terms used in some embodiments of the present disclosure are only for the purpose of describing specific embodiments, and are not intended to limit the present disclosure.

It is further understood that in the present disclosure, “multiple/plurality of” refers to two or more than two, and other quantifiers are similar thereto. “And/or” describes the association relationship of associated objects, indicating that three relationships may exist. For example, A and/or B may represent: A exists alone, both A and B exist, and B exists alone. The character “/” generally indicates that the associated objects before and after are in an “or” relationship. The singular forms “a”, “the” and “said” are also intended to include plural forms, unless the context clearly indicates other meanings.

It is further understood that the meanings of the words “in response to” and “if” involved in the present disclosure depend on the context and the actual usage scenario. For example, the word “in response to” used herein can be interpreted as “upon . . . ” or “when . . . ” or “if”.

It is further understood that the terms “first”, “second”, and the like are used to describe various information, but such information should not be limited to these terms. These terms are only used to distinguish the same type of information from each other and do not indicate a specific order or importance. In fact, expressions such as “first” and “second” can be used interchangeably. For example, without departing from the scope of this disclosure, the first information can also be referred to as the second information, and similarly, the second information can also be referred to as the first information.

It is further understood that, although the operations are described in a specific order in the drawings according to some embodiments of the present disclosure, it should not be understood as requiring the operations to be performed in the specific order shown or in a serial order, or requiring the execution of all the operations shown to obtain the desired results. In certain environments, multitasking and parallel processing may be advantageous.

Those skilled in the art will readily appreciate other embodiments of the present disclosure after considering the specification and practicing the invention disclosed herein. This application is intended to cover any modifications, uses or adaptations of the present disclosure, which follow the general principles of the present disclosure and include common knowledge or customary technical means in the art that are not disclosed in the present disclosure.

It should be understood that the embodiments of the present disclosure are not limited to the precise structures described above and shown in the drawings, and various modifications and changes may be made without departing from the scope thereof. The scope of the present disclosure is limited only by the appended claims.

1. A communication method performed by a network device, the communication method comprising:
sending broadcast information, wherein the broadcast information includes a parameter used for an artificial intelligence (AI) operation.

2. The communication method according to claim 1, wherein the parameter used for the AI operation comprises: at least one of a generic parameter or a specific parameter;
the generic parameter is applicable to AI operations of all AI feature instances;
the specific parameter is specific to AI operations of a single AI feature instance.

3. The communication method according to claim 1, wherein the parameter used for the AI operation comprises a respective parameter of a cell sending the broadcast information; and
the parameter of the cell comprises at least one:
whether the cell supports an AI feature instance;
configuration information corresponding to the cell;
data distribution information of the cell; or
AI model download information of the cell.

4. The communication method according to claim 3, wherein the parameter of the cell comprises that the cell supports the AI feature instance, and the method further comprises:
sending first information, wherein the first information indicates a terminal type applicable to the AI feature instance supported by the cell;
wherein the terminal type indicates a first-type terminal or a second-type terminal, and the first-type terminal and the second-type terminal have different communication capabilities.

5. The communication method according to claim 3, wherein the configuration information corresponding to the cell comprises at least one of:
antenna configuration information;
cell type information; or
scenario information of the cell.

6. The communication method according to claim 3, wherein the data distribution information of the cell comprises:
data set information indicating data distribution of the cell.

7.-12. (canceled)

13. A communication method performed by a terminal, the communication method comprising:
receiving broadcast information, wherein the broadcast information includes a parameter used for an artificial intelligence (AI) operation.

14. The communication method according to claim 13, wherein the parameter used for the AI operation comprises: at least one of a generic parameter or a specific parameter;
the generic parameter is applicable to AI operations of all AI feature instances;
the specific parameter is specific to AI operations of a single AI feature instance.

15. The communication method according to claim 13, wherein the parameter used for the AI operation comprises a respective parameter of a cell sending the broadcast information; and
the parameter of the cell comprises at least one of:
whether the cell supports an AI feature instance;
configuration information corresponding to the cell;
data distribution information of the cell; or
AI model download information of the cell.

16. The communication method according to claim 15, wherein the parameter of the cell comprises that the cell supports the AI feature instance, and the method further comprises:
receiving first information, wherein the first information indicates a terminal type applicable to the AI feature instance supported by the cell;
wherein the terminal type indicates a first-type terminal or a second-type terminal, and the first-type terminal and the second-type terminal have different communication capabilities.

17. The communication method according to claim 15, wherein the configuration information corresponding to the cell comprises at least one of:
antenna configuration information;
cell type information; or
scenario information of the cell.

18. The communication method according to claim 15, wherein the data distribution information of the cell comprises:
data set information indicating data distribution of the cell.

19. The communication method according to claim 18, wherein the data set information indicates a correspondence between a data set and a terminal type.

20. The communication method according to claim 15, wherein the AI model download information of the cell comprises at least one of:
whether the cell provides an AI model for download;
model information of the AI model that the cell provides for download; or
demand information of a respective terminal corresponding to the AI model.

21. The communication method according to claim 13, wherein the broadcast information is dedicated to the AI operation.

22. The communication method according to claim 13, wherein the broadcast information comprises broadcast information for the AI operation and broadcast information for a non-AI operation.

23. The communication method according to claim 13, wherein the AI operation corresponds to multiple AI feature instances, and the broadcast information corresponding to the multiple AI feature instances comprises a single broadcast information or multiple broadcast information.

24. The communication method according to claim 13, wherein receiving the broadcast information comprises:
receiving the broadcast information based on a preset period; or
receiving the broadcast information after transmitting a sending request to a network device.

25.-28. (canceled)

29. A device for wireless communication, the device comprising:
a memory that stores instructions;
one or more processors that are communicatively coupled to the memory,
wherein the instructions when collectively executed cause the device to:
receive broadcast information, wherein the broadcast information includes a parameter used for an artificial intelligence AI operation.

30. A device for wireless communication, the device comprising:
a memory that stores instructions; and
one or more processors that are communicatively coupled to the memory;
wherein the instructions when collectively executed by the one or more processors, cause the device to act as the network device and perform the communication method according to claim 1.
